(19) United States
(12) Patent Application Publication
(10) Pub. No.: US 2020/0305237 A1
(43) Pub. Date: Sep. 24, 2020

(54) SELF-LIMITING SHEET HEATER AND STRUCTURES MADE THEREWITH

(71) Applicant: DUPONT ELECTRONICS, INC., Wilmington, DE (US)

(72) Inventors: Wei Wu, Hockessin, DE (US); Gregory Scott Blackman, Media, PA (US)

(21) Appl. No.: 16/825,743

(22) Filed: Mar. 20, 2020

Related U.S. Application Data
(60) Provisional application No. 62/822,414, filed on Mar. 22, 2019.

(51) Int. Cl. H05B 3/00; H05B 3/16; H05B 3/14

(52) U.S. Cl. CPC H05B 3/0019; H05B 3/146; H05B 3/16

(57) ABSTRACT

An electrically-energized heater comprises a sheet heater element and a control element in thermal communication therewith. Certain embodiments make the heater self-limiting.

### CROSS-REFERENCE TO RELATED APPLICATION

This application claims benefit under 35 USC 119(e) of U.S. Provisional Application Ser. No. 62/822,414, filed Mar. 22, 2019, which application is incorporated herein for all purposes by reference thereto.

### FIELD OF THE INVENTION

The present disclosure relates to a sheet-form electrical heater that is thermally self-limiting and usefully incorporated in a wide variety of structures and applications.

### TECHNICAL BACKGROUND

In a wide variety of applications that employ an electrical heater, especially ones wherein the heating is regulated by a thermostat or controller of another type, deleterious consequences can arise from a mechanical or electrical failure that allows the heater to run away, meaning that it continues to operate and generate heat even after the temperature of the heater or its surroundings reach an intended upper limit. The excess heat can be dangerous to both people and objects, as injuries can occur directly or from fire that is inadvertently ignited.

Self-limiting heaters, in which heat production is limited by inherent system properties, are thus valuable. In addition, an inherently self-limiting heater may, in some embodiments, also be self-regulating, meaning that the heater maintains a relatively constant temperature for an indefinite period after its initial heatup. Such embodiments beneficially eliminate the need for thermostatic or other like control systems.

### SUMMARY OF THE INVENTION

An aspect of the present invention provides an electrically-energized heater comprising:
(a) a sheet heater element having line and neutral electrical terminals, and being configured such that current supplied by an electrical energy source and presented at the line and neutral electrical terminals flows through the heater element, whereby heat is produced; and
(b) a control element in thermal communication with the sheet heater element but electrically insulated therefrom, the control element comprising NTC material and having a first terminal connected to the line terminal and a second terminal configured to be connected to an earth ground,
   and wherein the heater is configured to be connected to a controller capable of sensing a difference between an incoming current flowing into the line terminal from the electrical source and an outgoing current flowing from the neutral terminal back to the electrical source and, upon detection of the difference exceeding a preselected limit, to reduce or interrupt the incoming current.

The foregoing heater may further be incorporated in a heater system, that further comprises a controller configured and operably connected to sense a difference between an incoming current flowing into the line terminal from the electrical source and an outgoing current flowing from the neutral terminal back to the electrical source and, upon detection of the difference exceeding a preselected limit, to reduce or interrupt the current passing into the heater element from the electrical source.

Another aspect of the present invention provides an electrically-energized heater comprising:
(a) a sheet heater element having first and second heater terminals; and
(b) a control element having first and second control terminals and comprising a

PTC material, the control element being in thermal communication with the sheet heater element and electrically connected in series with the sheet heater element through a connection between the second heater terminal and the first control terminal,

and wherein the heater is configured to be connected to a source of electrical energy suitable for energizing the heater element through the first heater terminal and second control terminal.

In some embodiments, either of the foregoing heaters is flexible. The heater element in either may comprise a conductive polyimide composite material.

A further aspect of the invention is a method of heating an object, comprising:
(a) contacting the object with a heater as described above;
(b) electrically connecting the heater to an electrical energy source; and
(c) allowing the heater to reach an equilibrium temperature determined by the resistance of the sheet heater element and the control element of the heater.

### BRIEF DESCRIPTION OF THE DRAWINGS

The invention will be more fully understood and further advantages will become apparent when reference is made to the following detailed description of the preferred embodiments of the invention and the accompanying drawings, wherein like reference numerals denote similar elements throughout the several views and in which:

FIG. 1 is a schematic circuit diagram of a heater that employs a negative temperature coefficient sensor used to limit the heating of a sheet-form heater element;

FIG. 2 depicts in schematic cross-sectional view a heater having a negative temperature coefficient control element;

FIG. 3 depicts in schematic cross-sectional view a heater having a positive temperature coefficient control element;

FIG. 4A is a graph showing a modeling of the average surface temperature of a sheet-form heater element useful in constructing the present heater as a function of applied voltage, but operated without a control element; FIG. 4B is a contour plot showing the variation of surface temperature over the heater element at one of the voltage levels included in FIG. 4A;

FIG. 5A is a graph showing a modeling of the average surface temperature as a function of applied voltage of a material useful as a control element in the present heater, but without a separate heater element; FIG. 5B is a contour plot showing the variation of surface temperature over the heater element at one of the voltage levels included in FIG. 5A;

FIGS. 6A-9A depict in perspective view various configurations of a heater of the present invention employing a heater element and a PTC material as a control element; FIGS. 6B-9B are graphs showing modeled average surface temperature of the heater configurations as a function of the applied voltage corresponding to the configurations of FIGS. 6A-9B, respectively; and

FIGS. 10A and 11A depict in perspective view additional configurations of a heater of the present invention employing a heater element and a PTC material as a control element; FIGS. 10B-11B are graphs showing modeled average surface temperature of the heater configurations as a function of the applied voltage corresponding to the configurations of FIGS. 10A and 11A, respectively.

### DETAILED DESCRIPTION

Various aspects of the present disclosure relate to a sheet-form heater that directly incorporates inherent heat-sensing capability and is readily employed in a variety of structures and applications. In some embodiments the heater is self-limiting, meaning that it is inherently fail-safe without needing a separate control system to limit the amount of heat that can be produced after the heater or its immediate surroundings reach an upper limit temperature. Rather, the rate of heat generation is either moderated or the heater is deactivated above a limit temperature. In an embodiment, the heater is flexible, meaning that it can be bent to a round radius of 5 cm without causing structural damage such as delamination or impairing its functionality, and remain so during flexure and after being returned to its initial flat configuration. Some embodiments can be bent to a round radius of 3, 2, or 1 cm and remain functional. Various embodiments also exhibit good folding endurance, as measured using the MIT folding tester in accordance with ASTM Standard Test Method D2176-16. (ASTM Standard Test Methods are promulgated by ASTM International, West Conshohocken, Pa. Each such ASTM standard referenced herein is incorporated in its entirety for all purposes by reference thereto.)

### NTC Embodiment

One aspect provides a heater system that comprises a sheet-form heater element and a control element that: (i) has a negative thermal coefficient of electrical resistance (NTC) and (ii) communicates thermally with the heater element. The heater is configured to be connected to a controller capable of sensing a difference between an incoming current flowing into the line terminal from the electrical source and an outgoing current flowing from the neutral terminal back to the electrical source and, upon detection of the difference exceeding a preselected limit, to reduce or interrupt the incoming current. Also provided is a heater system that comprises such a heater and a suitable controller operably connected thereto.

A material having the NTC property (herein, an “NTC material”) exhibits an electrical resistance that decreases with increasing temperature, at least over a temperature range of interest. Semiconductors typically exhibit NTC behavior, but other materials exhibiting a suitable NTC behavior are also usable in the present heater system. NTC behavior may be characterized by a numerical value of the temperature coefficient, which represents the fractional change in resistance of an NTC element for an increase of one degree from a specified base temperature. For an NTC material, the coefficient has a negative numerical value. Since the resistance of NTC materials ordinarily does not change linearly with temperature, the exact magnitude of the NTC for a given material depends on the base temperature chosen.

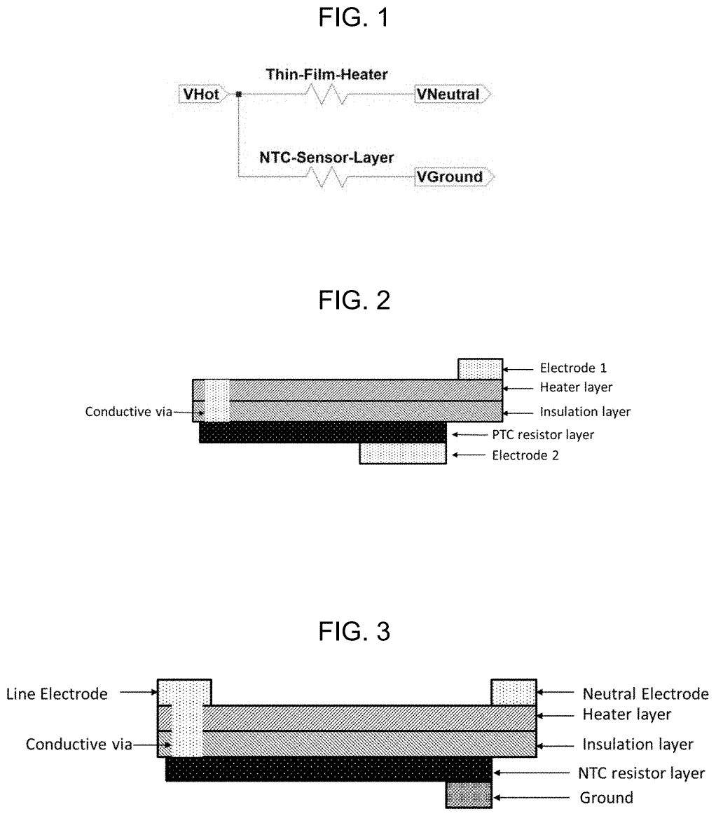

As depicted in the electrical diagram of FIG. 1, the sheet heater element in a representative NTC embodiment is connected at line (Vₕₒₜ) and neutral (Vₙₑᵤₜᵣₐₗ) terminals to an electrical energy source. Current presented at these terminals flows through the heater element to produce heat. Terminals of the control element are connected to the line terminal and to an earth ground (V_{ground}, so that a portion of the current coming from the energy source is shunted to ground and so does not return directly to the energy source through the neutral terminal. A controller (not shown) is configured to sense a difference between current at the line and neutral terminals due to this shunt current. Because of the negative temperature coefficient, the magnitude of the shunt current increases as the temperature of the control element increases and its resistance decreases. The controller is configured to limit the incoming current or to disconnect the heater element in response to detection of a difference between the incoming and outgoing current that exceeds a preselected limit.

Devices capable of performing some or all of these control functions are known in the art, and include ground fault circuit interrupters (GFCI) of the type conventionally used in residential and commercial wiring practice. US electrical codes typically call for a GFCI to interrupt the electrical supply at a fault or differential current of 5 mA for a 120 volt supply. Thus, a design employing such a GFCI circuit as a controller includes a negative temperature coefficient element having a resistance that drops below a value that results in a shunt current of 5 mA at a preselected upper temperature control limit.

In other embodiments, the controller has an on-off design, so that after the heater system reaches a preselected upper limit temperature, the controller detects a high differential current, causing it to interrupt the heater current. The heater can thus cool. The controller is configured to restore the current after sufficient cooling can be obtained, so that throughout the device's operation, temperature is maintained close to a set point. Still other embodiments employ a controller capable of continuously and adaptively regulating or cycling the heater current, based on the detected differential current, such that the heater maintains a desired steady state temperature, such as a proportional or PID controller. Control circuitry designs capable of one or more of these operational modes are known in the art.

FIG. 2 schematically depicts one possible implementation of a heater system that operates in accordance with the foregoing aspect. A DuPont Kapton® RS Polyimide film (available from E. I. duPont de Nemours and Co., Wilmington, Del.) provides the sheet heater element. As supplied commercially, this film is approximately 50 μm thick and comprises two sub-layers bonded to each other, one a dielectric insulator and the other being electrically conductive with a surface resistance of about 100 Ω/square. The conductivity of the Kapton® RS Polyimide film is understood to be provided by a carbon-based conductive material that is dispersed uniformly throughout the conductive layer, so that defects such as punctures, holes, or tears affect the current flow only in the immediate vicinity of the defect and so do not markedly affect the overall conduction pattern or disrupt the overall uniform generation of heat when the layer is energized. Other heating elements having suitable electrical and mechanical properties may alternatively be used. For example, a sheet-form polymeric material having a surface metallization layer or other conductive surface material might also be used.

A control element is provided by a layer of NTC material configured with first and second electrical terminals. In the embodiment depicted in FIG. 2, the connection between the first terminal and the line terminal is made using a via that penetrates the heater element. Without limitation, the connection is made using any convenient technique, including foil connector technologies, soldering, conductive adhesives, or zero insertion force connectors. The second terminal is configured to be electrically connected to earth ground. Other structures and types of connections that function similarly are also contemplated.

Materials that can be used to fabricate the NTC control element include, without limitation, silicon nano-ink; poly(3,4-ethylenedioxythiophene):poly(styrenesulfonate) (PEDOT:PSS), a nickel oxide ink, a vanadium-vanadium pentoxide multi-layer structure, or a material having a negative thermal coefficient of resistance mixed with a low melting point electrically conductive matrix material (see, e.g., paragraphs [0013]-[0015] of U.S. 2012/0248092 A1). Descriptions of the foregoing materials are provided in the technical and patent literature, including:

Junshi Soeda et al., Jpn. J. Appl. Phys. 56, 070310 (2017);

I I Woong Kwon et al., Synthetic Materials, Vol. 159, pp. 1174-1177, (2009);

Chun-Chih Huang et al., ACS Appl. Mater. Interfaces, 2013, 5 (24), pp 12954-12959 (2013);

M. Abdel-Rahman, Infrared Physics and Technology, Volume 71, p. 127-130 (2015); and

U.S. 2012/0248092 A1.

### PTC Embodiment

Another aspect of this disclosure provides a heater system that employs a sheet heater element and a control element that includes a material having a positive thermal coefficient of electrical resistivity (herein, a “PTC material”), with the heater element being electrically connected in series with the control element. A PTC material is one whose electrical resistance increases with increasing temperature. PTC behavior is characterized by a temperature coefficient defined in the same way as it is for NTC materials, but the value of the coefficient is positive instead of negative. Although metals and other ordinary conductive materials that function by metallic conduction exhibit PTC behavior, the magnitude of the PTC effect is relatively small for most. As a result, the present heater system is beneficially constructed with PTC materials with larger PTC coefficients, such as materials wherein the PTC effect is caused by internal structural changes. Some classes of such materials include particles of metal or other highly conductive material in a polymer matrix that softens, melts, or expands above a transition temperature. The resulting change in microstructure alters conductive pathways that allow current to flow through a succession of linked, adjacent particles. In the cooled state, the concentration of conductive material is ordinarily above a percolation limit. As a result, the resistivity of these PTC materials changes, often rather abruptly in the vicinity of a transition temperature, and with a rate of change that increases faster than linearly with temperature, and sometimes exponentially. An exemplary material of this type is DuPont 7292 PTC Carbon Resistor paste (available commercially from DuPont Microcircuit Materials, Research Triangle Park, N.C.). PTC materials are also discussed in U.S. Pat. No. 9,573,438, which is incorporated herein in its entirety for any purpose by reference thereto.

The heater and control elements of the present system communicate thermally, but are electrically connected only at the intended series connection. When energized, current flows serially through both elements, resulting in ohmic heating. As the temperature experienced by the control element increases, its resistivity increases, thereby increasing the resistance of the series combination. For a constant voltage supply, the heat produced decreases inversely with the series resistance, thereby providing the desired self-limitation. Certain PTC embodiments beneficially do not require the use of an external controller of any type.

FIG. 3 shows one possible implementation of a heater system according to this aspect. The heater element is again fabricated with DuPont Kapton® RS Polyimide film. The control element comprises a PTC resistive element provided by a layer formed using DuPont 7292, a polymer-based paste that includes a relatively high loading of a carbon-based conductive material. It or other materials may be deposited by any convenient method including, without limitation, screen printing, doctor blading, ink jet or aerosol jet printing, gravure, offset, or flexographic printing, evaporative shadow mask printing, microcontact printing, or lithography. Thereafter, the PTC paste is dried, cured, or fired to produce the desired electrical properties. A polyimide based heater element is beneficial for its ability to tolerate higher temperatures during firing than other polymer substrates. However, other processing permits use of other, less thermally robust materials for either the heater or the control element. The heater system is configured to be electrically energized by connecting it to an electrical source through electrodes 1 and 2, which connect respectively to the heater element and the control element (either directly or optionally through one or more intermediate conductive structures). When energized, current introduced at electrode 1 flows first through the heater element and then, in series connection, through the control element to electrode 2. The heater and control elements are interconnected, e.g. using connection techniques similar to those described above, through a via penetrating the heater element. Other suitable materials are alternatively used for either or both of the heater element and the PTC control element.

The particular geometrical configuration and the materials used are selected to provide the requisite thermal and electrical characteristics. For example, the resistance of a paste-deposited PTC control element is determined by factors that include the inherent properties of the material itself and the conductive geometry, including both the overall length, width and thickness of the trace and the possible use of plural sub-elements that may be arranged in various parallel or series electrical connections. For any particular material, the resistance is lowered by maximizing either or both of a layer's thickness and its cross-sectional area, e.g. by depositing a thick layer of material that covers as much of the bottom side of the heater element as possible. Higher resistance is obtainable with a thinner layer or by depositing the material in a patterned conductive trace having a longer effective path length, such as a meander pattern. Different PTC materials may exhibit one or more of different inherent conductivity at low temperature, different transition temperature ranges, and different numerical values of the PTC. Ordinarily, temperature may be controlled over a narrower target range by using a material with a higher thermal coefficient, at least over the temperature range of interest. Embodiments in which the PTC material is in thermal contact with a large portion of the active heater surface will ordinarily provide more uniform heating over the entire surface and fewer and less extreme hot spots.

The uniformity of surface temperature in certain embodiments of both the NTC- and PTC-based heaters herein may be further enhanced by including a heat spreading layer, such as a multilayer sheet of ultra high molecular weight polyethylene (UHMWPE). Representative examples are disclosed in commonly owned U.S. Patent Application Publication U.S. 2017/0373360A1 to Burkhardt et al., which is incorporated herein in its entirety for all purposes by reference thereto. Materials of this type are available commercially as DUPONT™ TEMPRION™ OHS Organic Heat Spreader (available from E. I. du Pont de Nemours and Company, Wilmington, Del.). Another possible heat spreading material is highly thermally conductive graphite. A representative example is Neograf eGraf Spreadershield (available from Sur-Seal Corporation, Cincinnati, Ohio).

The present heater system may be constructed with any material that exhibits sufficiently strong PTC behavior. For example, the PTC effect may be seen with composite polymeric materials having a loading of conductive particles that is above the percolation limit, such as the DuPont 7292 paste described above. Without being bound by any theory, it is believed that below a critical temperature range, the polymer constrains the particles to remain in contact, affording a continuous path for conducting current. The change in resistance with temperature, and thus the temperature coefficient, is relatively small in this temperature regime. As the temperature rises into a critical range or above a critical temperature, mechanical changes in the polymer, such as one or more of differential thermal expansion, exceeding a glass transition temperature, or other effect, are believed to allow the conductive particles to move, reducing the extent of particle-to-particle contact; electrical resistivity thus increases, ordinarily with a much higher PTC value in this regime. Changing the polymer matrix or its type, or the morphology or loading of the included particles may alter the electro-thermal behavior of the composite. However, the exact mechanism that gives rise to PTC behavior is not critical to operation of the present system, so that other types of PTC material are contemplated as well. The PTC phenomenon is discussed in detail in U.S. Pat. No. 5,714,096, which is incorporated herein in its entirety for any purpose by reference thereto. In an embodiment, the PTC material used in the present heater system is such that the control system has a resistance that increases by a factor of at least 5, 10, or 15 over a temperature range that is at most 30, 50, 75, or 100° C. wide. Although metals, intermetallics, and other conductors that exhibit metallic conductivity typically have a resistance that increases with temperature, most are not suitable for the control element, because their change in resistivity is too low for them to self-regulate or self-limit. Hence, they are not regarded as PTC materials, as that term is used herein.

In an embodiment, the control element herein employs material exhibiting PTC behavior that is stable and reproducible after thermal cycling.

Control elements made by depositing PTC material in the form of a paste composition that is thereafter dried or fired are subject to certain production constraints. These tend to limit the range of electrical properties that can be reliably and consistently obtained. For example, it is found to be difficult to deposit and fire layers that are either too thick or too thin. Thick layers tend to exhibit cracking and inconsistent resistance as manufactured, and are more vulnerable to subsequent damage from flexure or other handling and fabrication difficulties. Thin layers are vulnerable to inconsistent deposition. Together, such impediments limit thickness as a means to obtain a wide range of resistances with a given PTC material. Materials other than DuPont 7292 that use different conductive particles, different loading fraction, or different matrix polymers, afford other possibilities for altering the resistance of the PTC element and its operating temperature characteristics.

According to Ohm's law, the total amount of heat produced by a heater system of this configuration is given by V²/Rₜₒₜₐₗ, in which V is the supply voltage and Rₜₒₜₐₗ is the resistance of the heater element Rₛ and the control element R_{c} in series combination, so Rₜₒₜₐₗ=Rₛ+R_{c}, neglecting minimal contact and other parasitic resistances. Both resistances contribute to the total heat produced, commensurate with their relative values. In order to obtain self-limiting behavior, R_{c} must increase sufficiently so that at the desired average control temperature it dominates Rₛ. If Rₛ>>R_{c} at low temperature, then a large PTC is required for meaningful control. If Rₛ<<R_{c} at low temperature, then during operation a preponderance of the generated heat arises from the control element itself. Uniform heating over the entire heater area is promoted by having the control element be as commensurate in size with the heater element as possible, especially if Rₛ<<R_{c}. In an embodiment, a ratio Rₛ/R_{c} is at least 1, 2, 5, 10, or more at low temperature.

In some embodiments, suitable choices for the location and geometry of the control element and the values of Rₛ and R_{c} are believed to permit the average temperature at which the heater system self limits to be adjusted over a range, without changing the control element material or its temperature-dependent resistance behavior. Configurations demonstrating this behavior are seen in computer modeling set forth in the examples below.

The present self-limiting heater, in either of the aforementioned types, is beneficially incorporated in a variety of end uses that may have different physical configurations and different desired operating temperatures and commensurate power density. These uses include, without limitation: (i) heating for sidewalks and pavement, where the design temperature is selected to remove accumulated frozen precipitation ice or to prevent its accumulation; (ii) protection of water pipes or other fluid-carrying pipes from freezing; (iii) heating of roofing materials to mitigate formation of ice dams during winter precipitation and freezing conditions; (iv) warming of carpet and other flooring materials for human comfort in buildings; (v) chairs of any type that are heated to improve a user's comfort; (vi) heated countertops, in which the present heater might be embedded in solid surface countertop materials for maintaining the temperature of foodstuffs during served or sanitizing the surface; and (vii) cooktops with an embedded heater structure. Of these, applications involving melting ice typically are designed in view of the 0° C. freezing point of water, those relating to human comfort operate at temperatures set by comfortable indoor temperatures and human body temperature, and food applications are governed by temperatures needed to safely and conveniently hold and cook foodstuffs.

### EXAMPLES

The operation and effects of certain embodiments of the present invention may be more fully appreciated from the examples described below. The embodiments on which the computer simulations of these examples are based are representative only, and the selection of these embodiments to illustrate aspects of the invention does not indicate that materials, components, conditions, techniques and/or configurations not described are not suitable for use herein, or that subject matter not described in the examples is excluded from the scope of the appended claims and equivalents thereof.

### Computer Simulation of Self-Limiting Heater Systems

The electro-thermal behavior of certain self-limiting heater systems that use a PTC control element was studied using computer modeling. The modeling was carried out using COMSOL Multiphysics 5.3 finite element modeling software with electrical and thermal modules (available from COMSOL, Inc., Burlington, Mass.), so that the coupled electrical and thermal behavior in each configuration could be simulated. All the modeling was done assuming a 20° C. ambient temperature.

For each example, the heater element was assumed to have the electrical properties of a sheet of DuPont Kapton® RS Polyimide film of the size described. The control element had a defined shape and was assumed to be formed on a bottom surface of the heater element and connected near one end of the heater element through a via penetrating the insulative sub-layer of the polyimide. The properties of the PTC control element were assumed to be those of either DuPont 7292 paste or a novel, in-house experimental material. The manufacturer represents that a film of DuPont 7292 material that is 6-9 μm thick has a room-temperature sheet resistance of about 10-18 kΩ/square after curing. Thicker films made by doctor blade deposition of DuPont 7292 have been found to have a room-temperature sheet resistance of approximately 1000-2000 Ω/square for typical thicknesses. The material is also said to have a temperature dependence of resistivity showing more than a 10-fold increase between 20 and 80° C., with the resistivity rising rapidly above about 60° C. The experimental PTC composition was assumed to have a room-temperature resistance about 25 times lower, but a similar temperature dependence as the 7292 paste.

The heater, comprising the sheet heater element connected in series with the control element, was assumed to be energized at a specific constant voltage through terminals at one edge of the heater and at the opposite end of the control element. Configurations having various sizes and placement of the control element were simulated. Heat transfer from the heater was assumed to occur by free convection in ambient 20° C. with a transfer coefficient of 10 W/K⋅m² and an emissivity of 0.8.

### Comparative Example 1

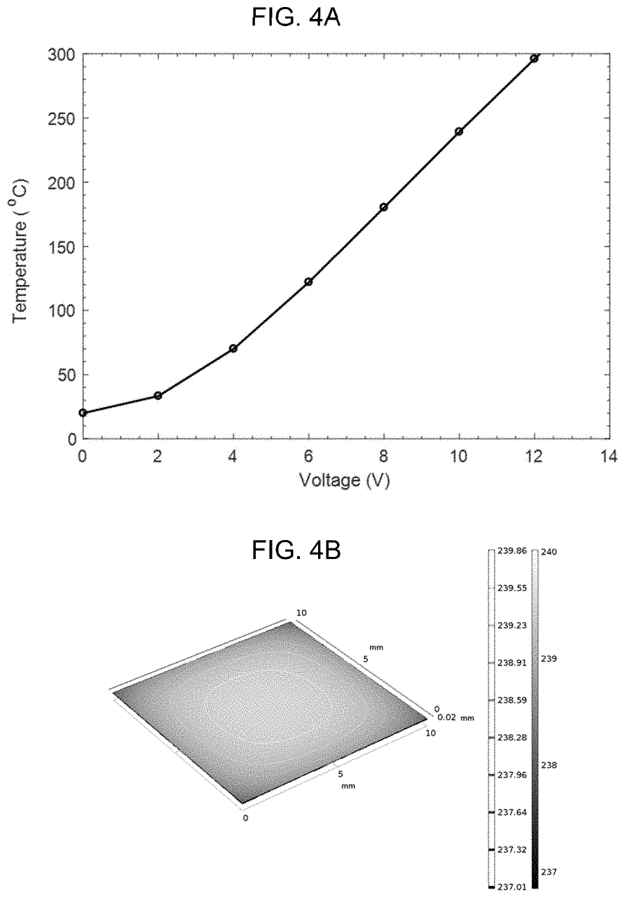

The behavior of a single 1 cm square sheet of DuPont Kapton® RS Polyimide film was modeled. The sheet was presumed to be energized at a series of voltages of 0-14 V applied to electrodes situated on opposite surface edges. The resistance of the film was inferred from the standard formula for a sheet, R=R_{S}×(l/w), in which R_{S} is the sheet resistance for a square sheet of a given thickness and l and w are length and width of the sheet. The surface temperature of the film in the steady state, averaged over the whole surface, was calculated as a function of the applied voltage. The simulation results are depicted in FIG. 4A. The average temperature, which was not constrained by any temperature regulating element, increased with voltage. FIG. 4B provides a contour map of steady-state temperature for excitation at a constant 10 V, showing that the calculated temperature was relatively uniform across the entire film.

### Comparative Example 2

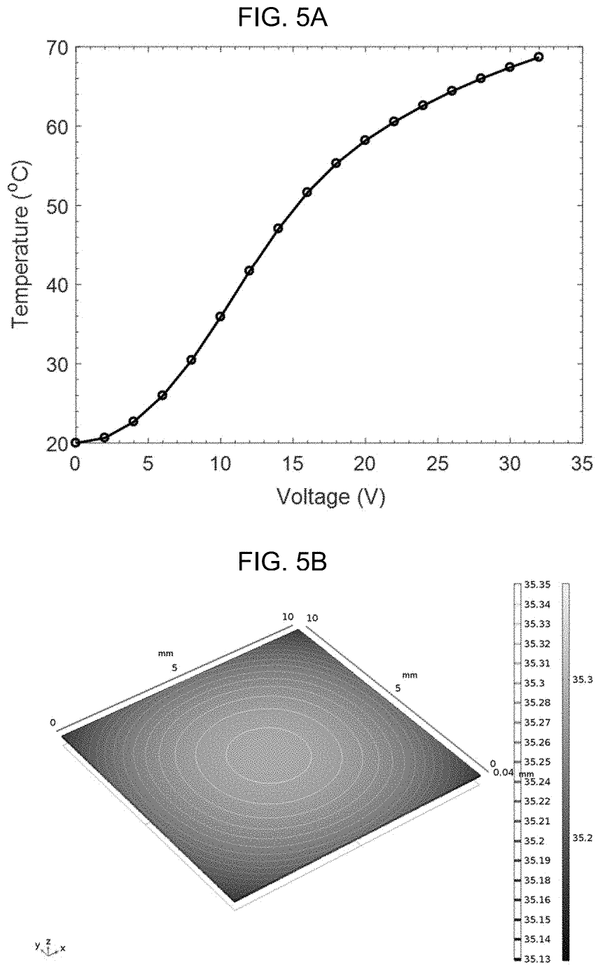

The behavior of a 1 cm square layer of film of DuPont 7292 paste with a 50 μm thickness, deposited on a 50 μm polyimide substrate, was simulated. The manufacturer's specification for resistivity ρ (0.1 Ω⋅m at 20° C.) was used to calculate a resistance R of 2000 Ω using the standard formula, R=ρ×l/(w×t) for a material having a length l along the current path and a width w and a thickness tin the plane perpendicular the current flow. Like the polyimide of Comparative Example 1, the film was presumed to be energized by applying voltage across opposite edges. The sheet resistance of the film as a function of temperature was calculated from data given in the manufacturer's data sheet. FIG. 5A depicts the calculated average surface temperature as a function of applied voltage. As a result of the PTC of this material, the increase in average temperature with applied voltage is limited. FIG. 5B provides a contour map of temperature for excitation at a constant 10 V, showing that the calculated temperature was relatively uniform across the entire PTC film.

### Examples 1-4

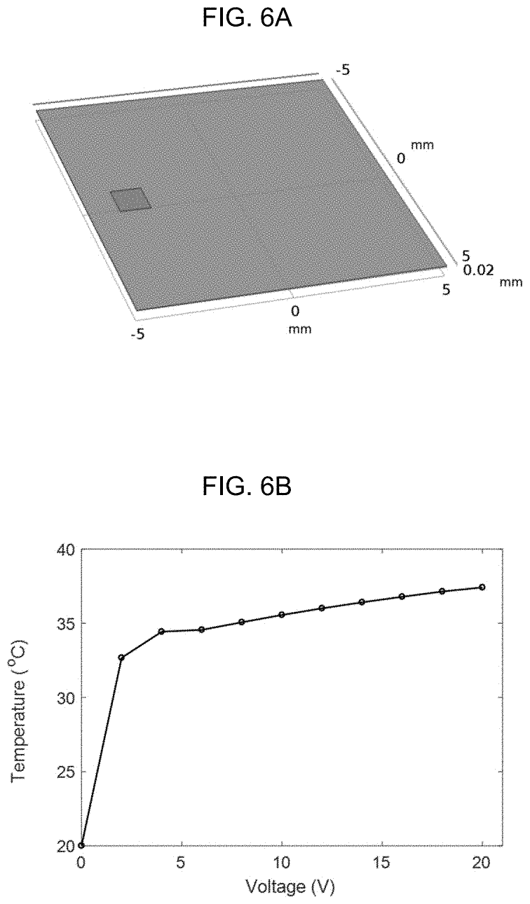

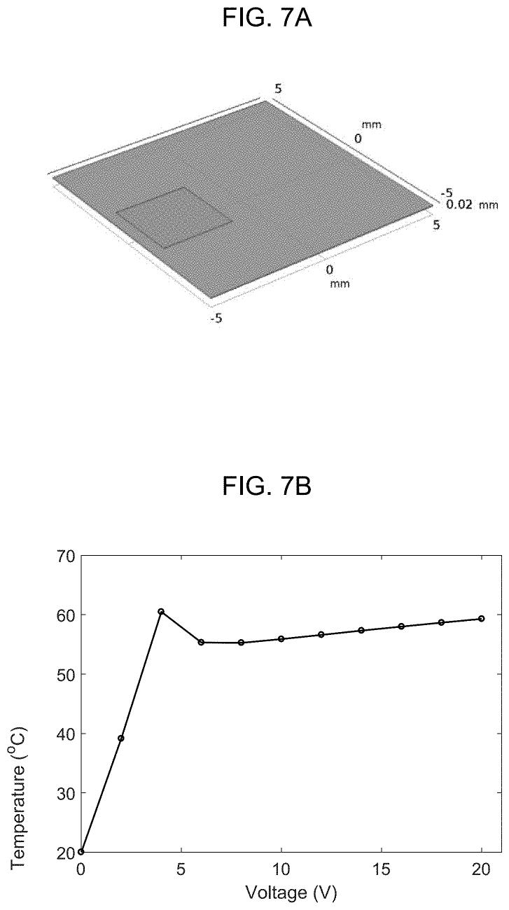

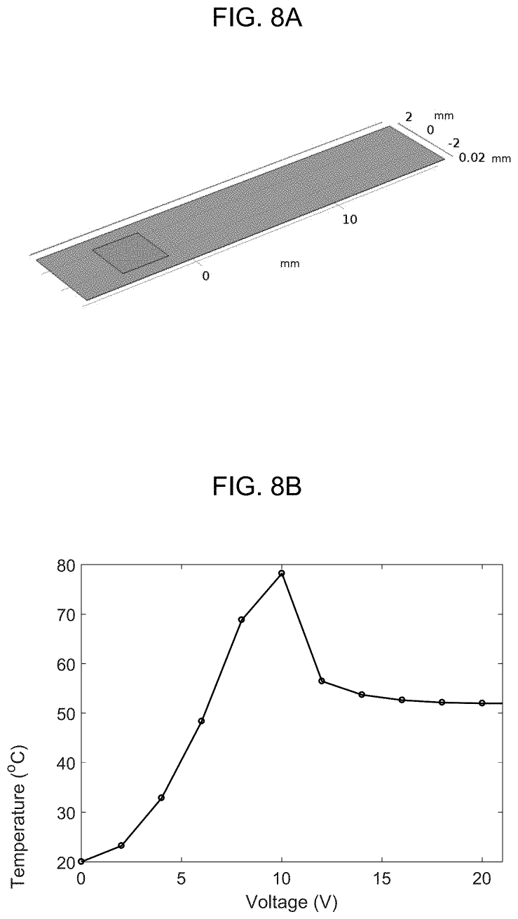

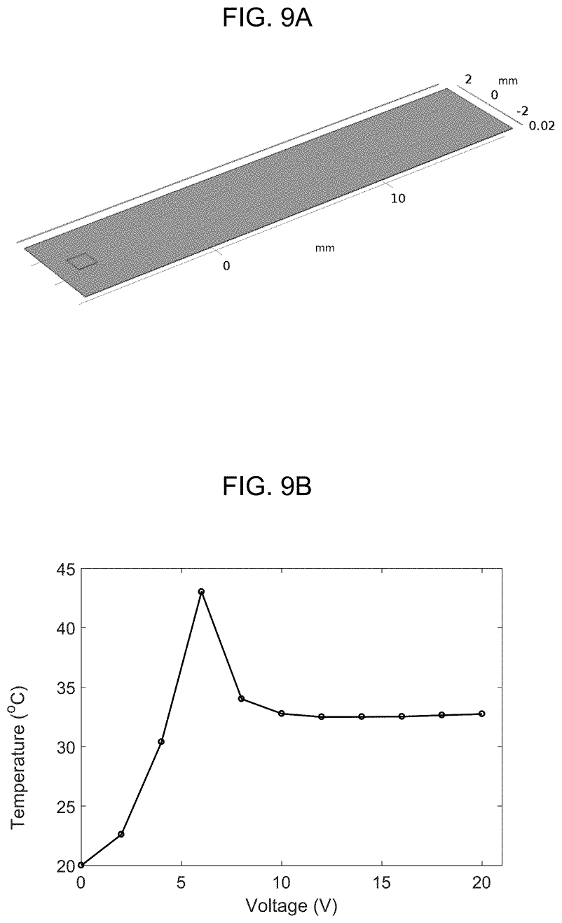

The Examples 1-4 provide computer modeling of the electro-thermal behavior of heater configurations that all involve a KRS heater element and a DuPont 7292 PTC control element formed in a square via situated near one edge of the heater element, as depicted in FIGS. 6A-9A, respectively. For Examples 1 and 2, the heater element is a 1 cm square; for Examples 3 and 4 it is a strip 0.5 cm wide and 2.5 cm long. The control element via is a square of 1 mm for Examples 1 and 4, and 3 mm for Examples 2 and 3; the vias all have a depth assumed to be 50.8 μm. Table I below summarizes the dimensions of the heater and control elements and their resistances, as inferred using the standard formulae given above. Each heater was assumed to be energized by a voltage applied between the bottom surface of the control element and the edge of the heater element opposite the control element.

TABLE I
Configuration and Resistance of PTC-Based Heaters

| | Heater Element | | | Control Element | | |
|---|---|---|---|---|---|---|
| | Width | Length | Resistance | Width | Length | Resistance |
| Example | (cm) | (cm) | (Ω) | (mm) | (mm) | (Ω) |
| 1 | 1 | 1 | 100 | 1 | 1 | 5 |
| 2 | 1 | 1 | 100 | 3 | 3 | 0.5 |
| 3 | 0.5 | 2.5 | 500 | 3 | 3 | 0.5 |
| 4 | 0.5 | 2.5 | 500 | 1 | 1 | 5 |

The average surface temperature of the heater element was calculated for each configuration as a function of the applied voltage, yielding the modeled results shown in FIGS. 6B-9B for Examples 1-4, respectively.

### Examples 5-6

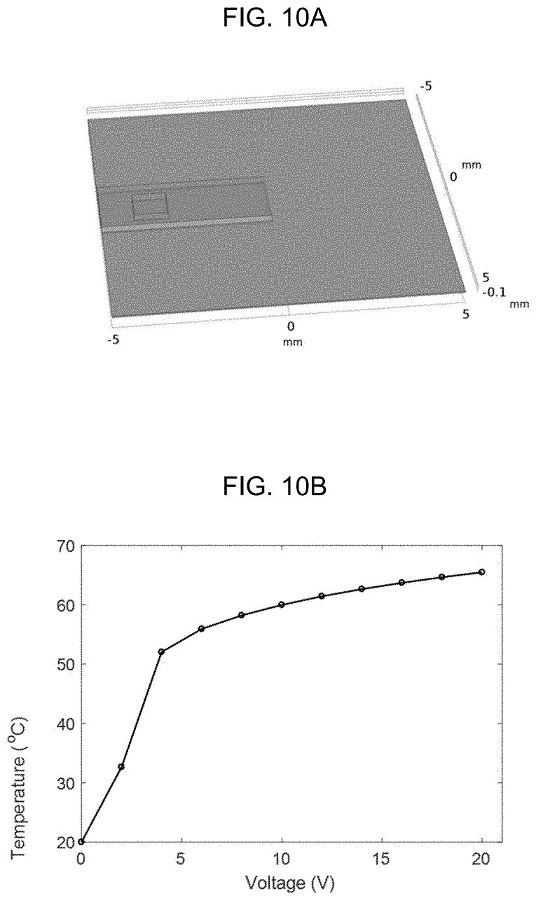

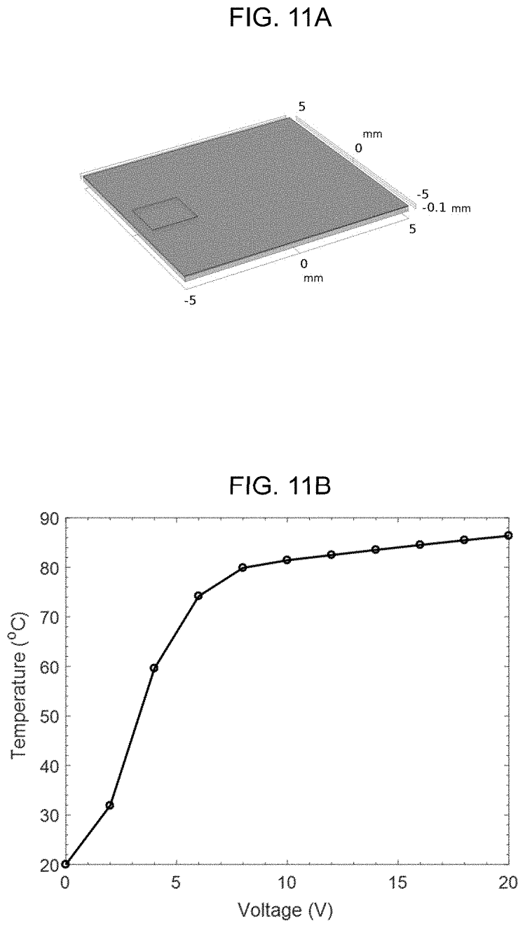

Additional heater configurations were modeled for Examples 5-6. Both included a 1 cm square KRS heater element (100 Ω resistance) and a control element formed with a PTC material having a resistivity at 20° C. of about 0.004 Ω⋅m, or about 25 times lower than DuPont 7292 material, but a similar temperature behavior. The control element comprised material that connected to the heater element through a square via 0.25 mm deep and extended onto the bottom surface of the heater element. For Example 5, the extension was a rectangular strip 2 mm wide, 4.5 mm long, and 0.2 mm thick; for Example 6, the extension was a 10 mm square 0.2 mm thick. The control element's 20° C. resistance was calculated as a series combination of the resistance of the material through the thickness of the via and along the strip. The dimensions of the via and the associated extension of each PTC control element are set forth in Table II below, along with its inferred total resistance. The respective configurations are depicted in FIGS. 10A and 11A.

TABLE II
Configuration and Resistance of PTC-Based Heaters

| | | | | | | | | Control |
|---|---|---|---|---|---|---|---|---|
| | Control Element Square Via | | | Control Element Extension | | | | Element Total |
| | Width | Depth | Resistance | Width | Thickness | Length | Resistance | Resistance |
| Example | (mm) | (mm) | (Ω) | (mm) | (mm) | (mm) | (Ω) | (Ω) |
| 5 | 1 | 0.25 | 1 | 2 | 0.2 | 4.5 | 45 | 46 |
| 6 | 2 | 0.25 | 0.25 | 10 | 0.2 | 10 | 20 | 20.25 |

The average surface temperature of the heater element was calculated for each configuration as a function of the applied voltage, yielding the modeled results shown in FIGS. 10B and 11B for Examples 5 and 6, respectively.

Comparison of the graphs in FIGS. 6B through 11B demonstrates that the various configurations all exhibit thermal self-limiting at different temperatures. As demonstrated by FIG. 4A, a Kapton® RS Polyimide heater element by itself exhibited no self-limiting, but configurations that included both this polyimide heater material and a PTC control element showed self-limiting at temperatures different from that provided by a similar control element by itself, as seen in FIG. 5A.

Having thus described the invention in rather full detail, it will be understood that this detail need not be strictly adhered to but that further changes and modifications may suggest themselves to one skilled in the art, all falling within the scope of the invention as defined by the subjoined claims.

The embodiments of the heater and systems herein and their constituent materials and components described herein, including the examples, are not limiting; it is contemplated that one of ordinary skill in the art could make minor substitutions and not substantially change the desired properties and operation of the system.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of, or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present. Additionally, the term “comprising” is intended to include examples encompassed by the terms “consisting essentially of” and “consisting of.” Similarly, the term “consisting essentially of” is intended to include examples encompassed by the term “consisting of.”

Certain terminology may be employed herein for clarity and convenience of description, rather than for any limiting purpose. For example, the terms “forward,” “rearward,” “right,” “left,” “top,” “bottom,” “upper,” and “lower” designate directions in the drawings to which reference is made. The various drawings may depict the present heater oriented as it is intended to be installed and used atop a roadbed on the earth's surface or embedded in pavement situated atop the roadbed. Terminology of similar import other than the words specifically mentioned above likewise is to be considered as being used for purposes of convenience rather than in any limiting sense.

What is claimed is:

1. An electrically-energized heater comprising:
(a) a sheet heater element having line and neutral electrical terminals, and being configured such that current supplied by an electrical energy source and presented at the line and neutral electrical terminals flows through the heater element, whereby heat is produced, and (b) a control element in thermal communication with the sheet heater element but electrically insulated therefrom, the control element comprising NTC material and having a first terminal connected to the line terminal and a second terminal configured to be connected to an earth ground; and
wherein the heater is configured to be connected to a controller capable of sensing a difference between an incoming current flowing into the line terminal from the electrical source and an outgoing current flowing from the neutral terminal back to the electrical source and, upon detection of the difference exceeding a preselected limit, to reduce or interrupt the incoming current.

2. The heater of claim 1, wherein the heater is flexible.

3. The heater claim 1, wherein the sheet heater element has a sheet resistance of 10-500 Ω/square.

4. The heater of claim 1, wherein the sheet heater element comprises a polymer.

5. The heater of claim 4, wherein the sheet heater element comprises a polymer having a surface metallization.

6. The heater of claim 4, wherein the sheet heater element comprises a polymer having particles of a conductive material distributed therein.

7. The heater of claim 6, wherein the sheet heater element comprises a polyimide having a first sublayer and a second sublayer bonded thereto, the first sublayer being composed of a polyimide dielectric and the second sublayer being composed of a polyimide having particles of a conductive material distributed therein.

8. The heater of claim 1, wherein the control element comprises NTC material disposed on at least a portion of a surface of the sheet heater element.

9. The heater of claim 8, wherein the first terminal is connected to the line terminal through a via that passes through the sheet heater element.

10. The heater of claim 1, wherein the control element comprises a silicon nano-ink;
poly(3,4-ethylenedioxythiophene):poly(styrenesulfonate) (PEDOT:PSS), a nickel oxide ink, a vanadium-vanadium pentoxide multi-layer structure, or a material having a negative thermal coefficient of resistance mixed with a low melting point electrically conductive matrix material.

11. An electrically-energized heater system comprising the heater of claim 1 and a controller configured and operably connected to sense a difference between an incoming current flowing into the line terminal from the electrical source and an outgoing current flowing from the neutral terminal back to the electrical source and, upon detection of the difference exceeding a preselected limit, to reduce or interrupt the current passing into the heater element from the electrical source.

12. The heater system of claim 11, wherein the controller interrupts the current passing into the heater upon detection of a difference in current exceeding a preselected limit.

13. The heater system of claim 11, wherein the controller is a ground-fault circuit interrupter.

14. An electrically-energized heater comprising:
(c) a sheet heater element having first and second heater terminals; and
(d) a control element having first and second control terminals and comprising a PTC material, the control element being in thermal communication with the sheet heater element and electrically connected in series with the sheet heater element through a connection between the second heater terminal and the first control terminal, and wherein the heater is configured to be connected to a source of electrical energy suitable for energizing the heater element through the first heater terminal and second control terminal.

15. The heater of claim 14, wherein the heater is flexible.

16. The heater of claim 14, wherein the conductive layer has an electrical conductivity characterized by a sheet resistance of 10-500 Ω/square.

17. The heater of claim 14, wherein the conductive layer comprises a polymer.

18. The heater of claim 17, wherein the conductive layer comprises a polymer having a surface metallization.

19. The heater of claim 17, wherein the conductive layer comprises a polymer having particles of a conductive material distributed therein.

20. The heater of claim 19, wherein the conductive layer comprises a polyimide having a first sublayer composed of a polyimide dielectric and bonded to a second sublayer composed of a polyimide having particles of a conductive material distributed therein.

21. The heater of claim 14, wherein the control element comprises a layer of PTC material disposed on at least a portion of the sheet heater element.

22. The heater of claim 21, wherein the connection between the second heater terminal and the first control terminal is made through a via in the sheet heater element.

23. The heater of claim 14, wherein control element has a resistance that increases by a factor of at least 10 over a temperature range of at most 100° C.

24. A method of heating an object, comprising:
(a) contacting the object with a heater as recited by claim 1;
(b) electrically connecting the heater to the electrical energy source; and
(c) allowing the heater to reach an equilibrium temperature determined by the resistance of the sheet heater element and the control element.

25. A method of heating an object, comprising:
(a) contacting the object with a heater as recited by claim 14;
(b) electrically connecting the heater to the electrical energy source; and
(c) allowing the heater to reach an equilibrium temperature determined by the resistance of the sheet heater element and the control element.
